(19) United States
(12) Patent Application Publication
(10) Pub. No.: US 2009/0055736 A1
(43) Pub. Date: Feb. 26, 2009

(54) MOBILE TERMINAL, METHOD OF TRANSMITTING DATA THEREIN AND PROGRAM RECORDING MEDIUM THEREOF

(75) Inventor: Tae Sook Yoon, Incheon-si (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG Electronics Inc.

(21) Appl. No.: 12/102,849

(22) Filed: Apr. 14, 2008

(30) Foreign Application Priority Data
Aug. 20, 2007 (KR) 10-2007-0083357

(51) Int. Cl. G06F 3/00

(52) U.S. Cl. 715/700

(57) ABSTRACT

A mobile terminal, method of transmitting data therein and program recording medium thereof are disclosed, by which information can be transmitted by being converted to an image. The present invention includes a user input unit for a signal input, a display displaying a screen for an execution of an application relevant to a message, a controller extracting a message, converting the extracted message to an image, and controlling the image to be transmitted, and a wireless communication unit for transmitting the image.

This application claims the benefit of the Korean Patent Application No. 10-2007-0083357, filed on Aug. 20, 2007, which is hereby incorporated by reference as if fully set forth herein.

### BACKGROUND OF THE INVENTION

1. Field of the Invention

The present invention relates to a mobile terminal, and more particularly, to a mobile terminal, method of transmitting data therein and program recording medium thereof. Although the present invention is suitable for a wide scope of applications, it is particularly suitable for transmitting information by converting the information to an image.

2. Discussion of the Related Art

A mobile terminal is a device which may be configured to perform various functions. Examples of such functions include data and voice communications, capturing images and video via a camera, recording audio, playing music files via a speaker system, and displaying images and video on a display. Some terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components which form the mobile terminal.

And, data transmission is enabled using a mobile terminal.

However, in case that a mobile terminal for transmitting data fails to support the same function supported by another mobile terminal for receiving the data, the latter mobile terminal of a receiving side may have difficulty in confirming the received data correctly. So, many efforts have been made to research and develop smooth data communication between mobile terminals in capable of supporting the same function.

### SUMMARY OF THE INVENTION

Accordingly, the present invention is directed to a mobile terminal, method of transmitting data therein and program recording medium thereof that substantially obviate one or more problems due to limitations and disadvantages of the related art.

An object of the present invention is to provide a mobile terminal, method of transmitting data therein and program recording medium thereof, by which information can be transmitted by being converted to an image.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile terminal according to the present invention includes a user input unit for a signal input, a display displaying a screen for an execution of an application relevant to a message, a controller extracting a message, converting the extracted message to an image, and controlling the image to be transmitted, and a wireless communication unit for transmitting the image.

In another aspect of the present invention, a mobile terminal includes a user input unit for a signal input, a display displaying a screen, a controller performing image-capturing on the displayed screen and a virtual screen not displayed on the display, and controlling the captured image to be transmitted, and a wireless communication unit for transmitting the captured image.

In another aspect of the present invention, a recording medium has a program recorded therein wherein the program includes the steps of displaying an image for an execution of an application relevant to a message, extracting a message, converting the extracted message to an image, and transmitting the image.

In another aspect of the present invention, a recording medium has a program recorded therein wherein the program includes displaying a screen for an execution of an application relevant to a message, extracting a message, converting the extracted message to an image, and transmitting the image.

In another aspect of the present invention, a method of transmitting data in a mobile terminal includes displaying a screen, image-capturing the displayed screen and a virtual screen not displayed, and transmitting the captured image.

In another aspect of the present invention, a method of transmitting data in a mobile terminal includes displaying a screen for an execution of an application relevant to message, extracting a message, converting the extracted message to an image, and transmitting the image.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal in accordance with an embodiment of the present invention;

FIG. 2 is a perspective view of a front side of a mobile terminal according to an embodiment of the present invention;

FIG. 3 is a rear view of the mobile terminal shown in FIG. 2;

FIG. 4 is a block diagram of a CDMA wireless communication system operable with the mobile terminal of FIGS. 1 to 3;

FIG. 5 and FIG. 6 are diagrams for examples of performing a road guidance function fin a mobile terminal according to one embodiment of the present invention;

FIG. 7 is a diagram to explain data communication performed between a server and a mobile terminal according to one embodiment of the present invention;

FIG. 8 is a flowchart for a method of transmitting data in a mobile terminal according to one embodiment of the present invention;

FIG. 9 and FIG. 10 are diagrams to explain a method of transmitting an image converted from a message in a mobile terminal according to one embodiment of the present invention;

FIG. 11 is a diagram to explain a method of checking the image transmitted by the method shown in FIG. 9 in a receiving terminal having received the corresponding image;

FIG. 12 is a diagram to explain a method of checking the image transmitted by the method shown in FIG. 10 in a receiving terminal having received the corresponding image;

FIG. 13 is a flowchart for a method of transmitting data in a mobile terminal according to another embodiment of the present invention;

FIG. 14 and FIG. 15 diagrams to explain a method of transmitting a screen and a virtual screen captured in a mobile terminal according to one embodiment of the present invention;

FIG. 16 is a diagram to explain a method of checking the image transmitted by the method shown in FIG. 14 in a receiving terminal having received the corresponding image; and

FIG. 17 is a diagram to explain a method of checking the image transmitted by the method shown in FIG. 15 in a receiving terminal having received the corresponding image.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. It is to be understood by those of ordinary skill in this technological field that other embodiments may be utilized, and structural, electrical, as well as procedural changes may be made without departing from the scope of the present invention.

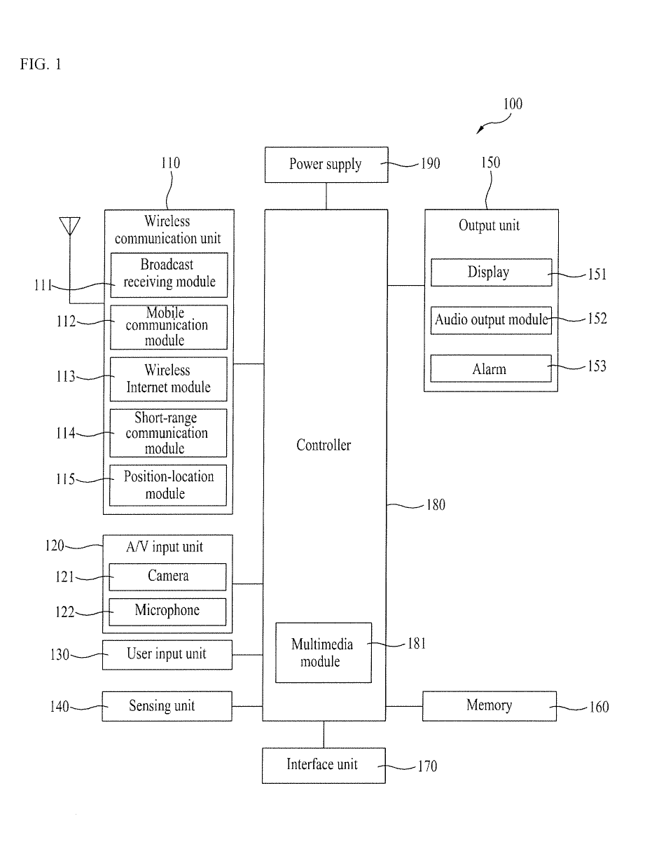

FIG. 1 is a block diagram of mobile terminal 100 in accordance with an embodiment of the present invention. The mobile terminal may be implemented using a variety of different types of terminals. Examples of such terminals include mobile phones, user equipment, smart phones, computers, digital broadcast terminals, personal digital assistants, portable multimedia players (PMP) and navigators. By way of non-limiting example only, further description will be with regard to a mobile terminal. However, such teachings apply equally to other types of terminals. FIG. 1 shows the mobile terminal 100 having various components, but it is understood that implementing all of the illustrated components is not a requirement. Greater or fewer components may alternatively be implemented.

FIG. 1 shows a wireless communication unit 110 configured with several commonly implemented components. For instance, the wireless communication unit 110 typically includes one or more components which permits wireless communication between the mobile terminal 100 and a wireless communication system or network within which the mobile terminal is located.

The broadcast receiving module 111 receives a broadcast signal and/or broadcast associated information from an external broadcast managing entity via a broadcast channel. The broadcast channel may include a satellite channel and a terrestrial channel. The broadcast managing entity refers generally to a system which transmits a broadcast signal and/or broadcast associated information. Examples of broadcast associated information include information associated with a broadcast channel, a broadcast program, a broadcast service provider, etc. For instance, broadcast associated information may include an electronic program guide (EPG) of digital multimedia broadcasting (DMB) and electronic service guide (ESG) of digital video broadcast-handheld (DVB-H).

The broadcast signal may be implemented as a TV broadcast signal, a radio broadcast signal, and a data broadcast signal, among others. If desired, the broadcast signal may further include a broadcast signal combined with a TV or radio broadcast signal.

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Receiving of multicast signals is also possible. If desired, data received by the broadcast receiving module 111 may be stored in a suitable device, such as memory 160.

The mobile communication module 112 transmits/receives wireless signals to/from one or more network entities (e.g., base station, Node-B). Such signals may represent audio, video, multimedia, control signaling, and data, among others.

The wireless internet module 113 supports Internet access for the mobile terminal. This module may be internally or externally coupled to the terminal.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

Position-location module 115 identifies or otherwise obtains the location of the mobile terminal. If desired, this module may be implemented using global positioning system (GPS) components which cooperate with associated satellites, network components, and combinations thereof.

Audio/video (A/V) input unit 120 is configured to provide audio or video signal input to the mobile terminal. As shown, the A/V input unit 120 includes a camera 121 and a microphone 122. The camera receives and processes image frames of still pictures or video.

The microphone 122 receives an external audio signal while the portable device is in a particular mode, such as phone call mode, recording mode and voice recognition. This audio signal is processed and converted into digital data. The portable device, and in particular, A/V input unit 120, typically includes assorted noise removing algorithms to remove noise generated in the course of receiving the external audio signal. Data generated by the A/V input unit 120 may be stored in memory 160, utilized by output unit 150, or transmitted via one or more modules of communication unit 110. If desired, two or more microphones and/or cameras may be used.

The user input unit 130 generates input data responsive to user manipulation of an associated input device or devices. Examples of such devices include a keypad, a dome switch, a touchpad (e.g., static pressure/capacitance), a jog wheel and a jog switch. A specific example is one in which the user input unit 130 is configured as a touchpad in cooperation with a touchscreen display (which will be described in more detail below).

The sensing unit 140 provides status measurements of various aspects of the mobile terminal. For instance, the sensing unit may detect an open/close status of the mobile terminal, relative positioning of components (e.g., a display and keypad) of the mobile terminal, a change of position of the mobile terminal or a component of the mobile terminal, a presence or absence of user contact with the mobile terminal, orientation or acceleration/deceleration of the mobile terminal. As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device.

The interface unit 170 is often implemented to couple the mobile terminal with external devices. Typical external devices include wired/wireless headphones, external chargers, power supplies, storage devices configured to store data (e.g., audio, video, pictures, etc.), earphones, and microphones, among others. The interface unit 170 may be configured using a wired/wireless data port, a card socket (e.g., for coupling to a memory card, subscriber identity module (SIM) card, user identity module (UIM) card, removable user identity module (RUIM) card), audio input/output ports and video input/output ports.

The output unit 150 generally includes various components which support the output requirements of the mobile terminal. Display 151 is typically implemented to visually display information associated with the mobile terminal 100. For instance, if the mobile terminal is operating in a phone call mode, the display will generally provide a user interface or graphical user interface which includes information associated with placing, conducting, and terminating a phone call. As another example, if the mobile terminal 100 is in a video call mode or a photographing mode, the display 151 may additionally or alternatively display images which are associated with these modes.

One particular implementation includes the display 151 configured as a touch screen working in cooperation with an input device, such as a touchpad. This configuration permits the display to function both as an output device and an input device.

The display 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal may include one or more of such displays. An example of a two-display embodiment is one in which one display is configured as an internal display (viewable when the terminal is in an opened position) and a second display configured as an external display (viewable in both the open and closed positions).

FIG. 1 further shows output unit 150 having an audio output module 152 which supports the audio output requirements of the mobile terminal 100. The audio output module is often implemented using one or more speakers, buzzers, other audio producing devices, and combinations thereof. The audio output module functions in various modes including call-receiving mode, call-placing mode, recording mode, voice recognition mode and broadcast reception mode. During operation, the audio output module 152 outputs audio relating to a particular function (e.g., call received, message received, and errors).

The output unit 150 is further shown having an alarm 153, which is commonly used to signal or otherwise identify the occurrence of a particular event associated with the mobile terminal. Typical events include call received, message received and user input received. An example of such output includes the providing of tactile sensations (e.g., vibration) to a user. For instance, the alarm 153 may be configured to vibrate responsive to the mobile terminal receiving a call or message. As another example, vibration is provided by alarm 153 responsive to receiving user input at the mobile terminal, thus providing a tactile feedback mechanism. It is understood that the various output provided by the components of output unit 150 may be separately performed, or such output may be performed using any combination of such components.

The memory 160 is generally used to store various types of data to support the processing, control, and storage requirements of the mobile terminal. Examples of such data include program instructions for applications operating on the mobile terminal, contact data, phonebook data, messages, pictures, video, etc. The memory 160 shown in FIG. 1 may be implemented using any type (or combination) of suitable volatile and non-volatile memory or storage devices including random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, card-type memory, or other similar memory or data storage device.

The controller 180 typically controls the overall operations of the mobile terminal. For instance, the controller performs the control and processing associated with voice calls, data communications, video calls, camera operations and recording operations. If desired, the controller may include a multimedia module 181 which provides multimedia playback. The multimedia module may be configured as part of the controller 180, or this module may be implemented as a separate component.

The power supply 190 provides power required by the various components for the portable device. The provided power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory (for example, memory 160), and executed by a controller or processor (for example, controller 180).

Mobile terminal 100 may be implemented in a variety of different configurations. Examples of such configurations include folder-type, slide-type, bar-type, rotational-type, swing-type and combinations thereof. For clarity, further disclosure will primarily relate to a slide-type mobile terminal. However such teachings apply equally to other types of terminals.

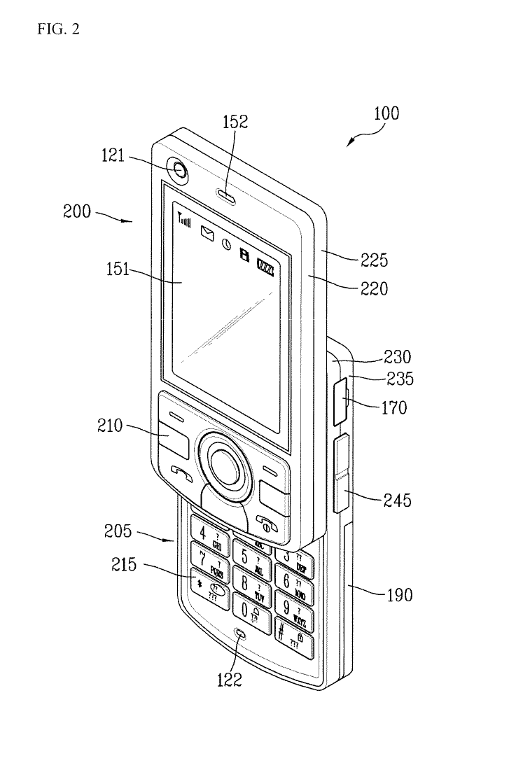

FIG. 2 is a perspective view of a front side of a mobile terminal according to an embodiment of the present invention. In FIG. 2, the mobile terminal 100 is shown having a first body 200 configured to slideably cooperate with a second body 205. The user input unit (described in FIG. 1) is implemented using function keys 210 and keypad 215. The function keys 210 are associated with first body 200, and the keypad 215 is associated with second body 205. The keypad includes various keys (e.g., numbers, characters, and symbols) to enable a user to place a call, prepare a text or multimedia message, and otherwise operate the mobile terminal.

The first body 200 slides relative to second body 205 between open and closed positions. In a closed position, the first body is positioned over the second body in such a manner that the keypad 215 is substantially or completely obscured by the first body 200. In the open position, user access to the keypad 215, as well as the display 151 and function keys 210, is possible. The function keys are convenient to a user for entering commands such as start, stop and scroll.

The mobile terminal 100 is operable in either a standby mode (e.g., able to receive a call or message, receive and respond to network control signaling), or an active call mode. Typically, the mobile terminal 100 functions in a standby mode when in the closed position, and an active mode when in the open position. This mode configuration may be changed as required or desired.

The first body 200 is shown formed from a first case 220 and a second case 225, and the second body 205 is shown formed from a first case 230 and a second case 235. The first and second cases are usually formed from a suitably ridge material such as injection molded plastic, or formed using metallic material such as stainless steel (STS) and titanium (Ti).

If desired, one or more intermediate cases may be provided between the first and second cases of one or both of the first and second bodies 200, 205. The first and second bodies 200, 205 are typically sized to receive electronic components necessary to support operation of the mobile terminal 100.

The first body 200 is shown having a camera 121 and audio output unit 152, which is configured as a speaker, positioned relative to the display 151. If desired, the camera 121 may be constructed in such a manner that it can be selectively positioned (e.g., rotated, swiveled, etc.) relative to first body 200.

The function keys 210 are positioned adjacent to a lower side of the display 151. The display 151 is shown implemented as an LCD or OLED. Recall that the display may also be configured as a touchscreen having an underlying touchpad which generates signals responsive to user contact (e.g., finger, stylus, etc.) with the touchscreen.

Second body 205 is shown having a microphone 122 positioned adjacent to keypad 215, and side keys 245, which are one type of a user input unit, positioned along the side of second body 205. Preferably, the side keys 245 may be configured as hot keys, such that the side keys are associated with a particular function of the mobile terminal. An interface unit 170 is shown positioned adjacent to the side keys 245, and a power supply 190 in a form of a battery is located on a lower portion of the second body 205.

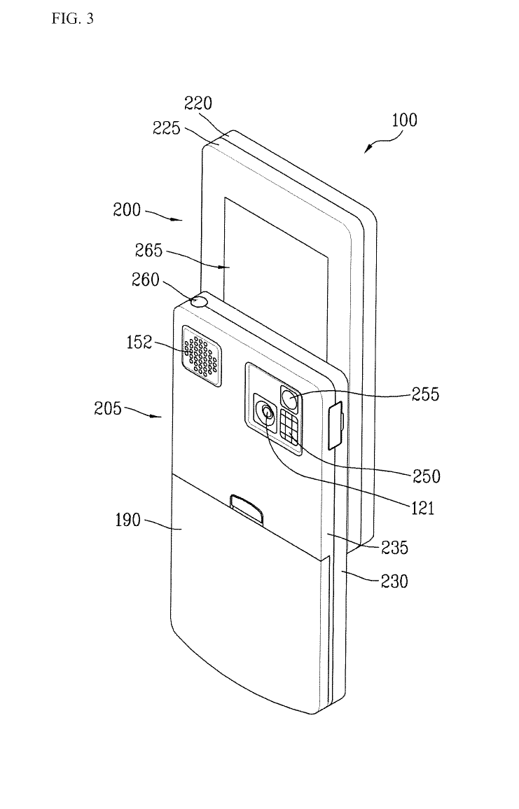

FIG. 3 is a rear view of the mobile terminal shown in FIG. 2. FIG. 3 shows the second body 205 having a camera 121, and an associated flash 250 and mirror 255. The flash operates in conjunction with the camera 121 of the second body. The mirror 255 is useful for assisting a user to position camera 121 in a self-portrait mode. The camera 121 of the second body faces a direction which is opposite to a direction faced by camera 121 of the first body 200 (FIG. 2). Each of the cameras 121 of the first and second bodies may have the same or different capabilities.

In an embodiment, the camera of the first body 200 operates with a relatively lower resolution than the camera of the second body 205. Such an arrangement works well during a video conference, for example, in which reverse link bandwidth capabilities may be limited. The relatively higher resolution of the camera of the second body 205 (FIG. 3) is useful for obtaining higher quality pictures for later use or for communicating to others.

The second body 205 also includes an audio output module 152 configured as a speaker, and which is located on an upper side of the second body. If desired, the audio output modules of the first and second bodies 200, 205, may cooperate to provide stereo output. Moreover, either or both of these audio output modules may be configured to operate as a speakerphone.

A broadcast signal receiving antenna 260 is shown located at an upper end of the second body 205. Antenna 260 functions in cooperation with the broadcast receiving module 111 (FIG. 1). If desired, the antenna 260 may be fixed or configured to retract into the second body 205. The rear side of the first body 200 includes slide module 265, which slideably couples with a corresponding slide module located on the front side of the second body 205.

It is understood that the illustrated arrangement of the various components of the first and second bodies 200, 205, may be modified as required or desired. In general, some or all of the components of one body may alternatively be implemented on the other body. In addition, the location and relative positioning of such components are not critical to many embodiments, and as such, the components may be positioned at locations which differ from those shown by the representative figures.

The mobile terminal 100 of FIGS. 1 to 3 may be configured to operate within a communication system which transmits data via frames or packets, including both wireless and wireline communication systems, and satellite-based communication systems. Such communication systems utilize different air interfaces and/or physical layers.

Examples of such air interfaces utilized by the communication systems include example, frequency division multiple access (FDMA), time division multiple access (TDMA), code division multiple access (CDMA), and universal mobile telecommunications system (UMTS), the long term evolution (LTE) of the UMTS, and the global system for mobile communications (GSM). By way of non-limiting example only, further description will relate to a CDMA communication system, but such teachings apply equally to other system types.

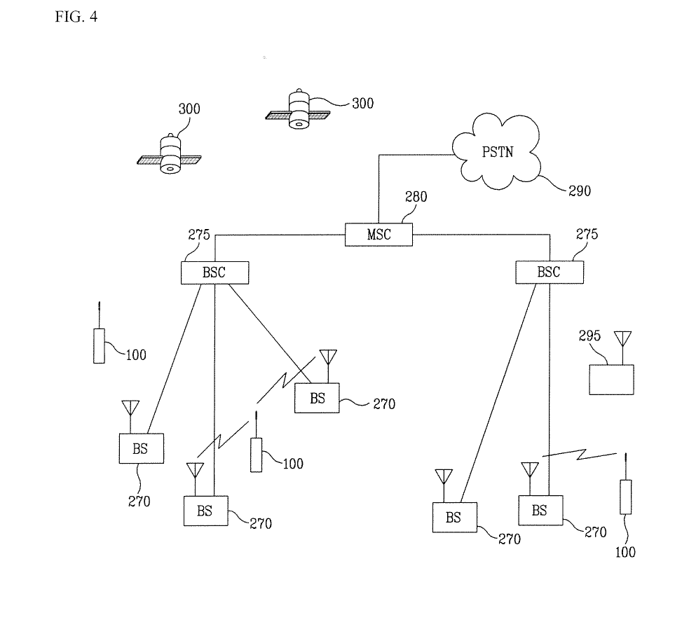

Referring now to FIG. 4, a CDMA wireless communication system is shown having a plurality of mobile terminals 100, a plurality of base stations 270, base station controllers (BSCs) 275, and a mobile switching center (MSC) 280. The MSC 280 is configured to interface with a conventional public switch telephone network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system may include more than two BSCs 275.

Each base station 270 may include one or more sectors, each sector having an omnidirectional antenna or an antenna pointed in a particular direction radially away from the base station 270. Alternatively, each sector may include two antennas for diversity reception. Each base station 270 may be configured to support a plurality of frequency assignments, with each frequency assignment having a particular spectrum (e.g., 1.25 MHz, 5 MHz).

The intersection of a sector and frequency assignment may be referred to as a CDMA channel. The base stations 270 may also be referred to as base station transceiver subsystems (BTSs). In some cases, the term “base station” may be used to refer collectively to a BSC 275, and one or more base stations 270. The base stations may also be denoted “cell sites.” Alternatively, individual sectors of a given base station 270 may be referred to as cell sites.

A terrestrial digital multimedia broadcasting (DMB) transmitter 295 is shown broadcasting to portable terminals 100 operating within the system. The broadcast receiving module 111 (FIG. 1) of the portable terminal is typically configured to receive broadcast signals transmitted by the DMB transmitter 295. Similar arrangements may be implemented for other types of broadcast and multicast signaling (as discussed above).

FIG. 4 further depicts several global positioning system (GPS) satellites 300. Such satellites facilitate locating the position of some or all of the portable terminals 100. Two satellites are depicted, but it is understood that useful positioning information may be obtained with greater or fewer satellites. The position-location module 115 (FIG. 1) of the portable terminal 100 is typically configured to cooperate with the satellites 300 to obtain desired position information. It is to be appreciated that other types of position detection technology, (i.e., location technology that may be used in addition to or instead of GPS location technology) may alternatively be implemented. If desired, some or all of the GPS satellites 300 may alternatively or additionally be configured to provide satellite DMB transmissions.

During typical operation of the wireless communication system, the base stations 270 receive sets of reverse-link signals from various mobile terminals 100. The mobile terminals 100 are engaging in calls, messaging, and other communications. Each reverse-link signal received by a given base station 270 is processed within that base station. The resulting data is forwarded to an associated BSC 275. The BSC provides call resource allocation and mobility management functionality including the orchestration of soft handoffs between base stations 270. The BSCs 275 also route the received data to the MSC 280, which provides additional routing services for interfacing with the PSTN 290. Similarly, the PSTN interfaces with the MSC 280, and the MSC interfaces with the BSCs 275, which in turn control the base stations 270 to transmit sets of forward-link signals to the mobile terminals 100.

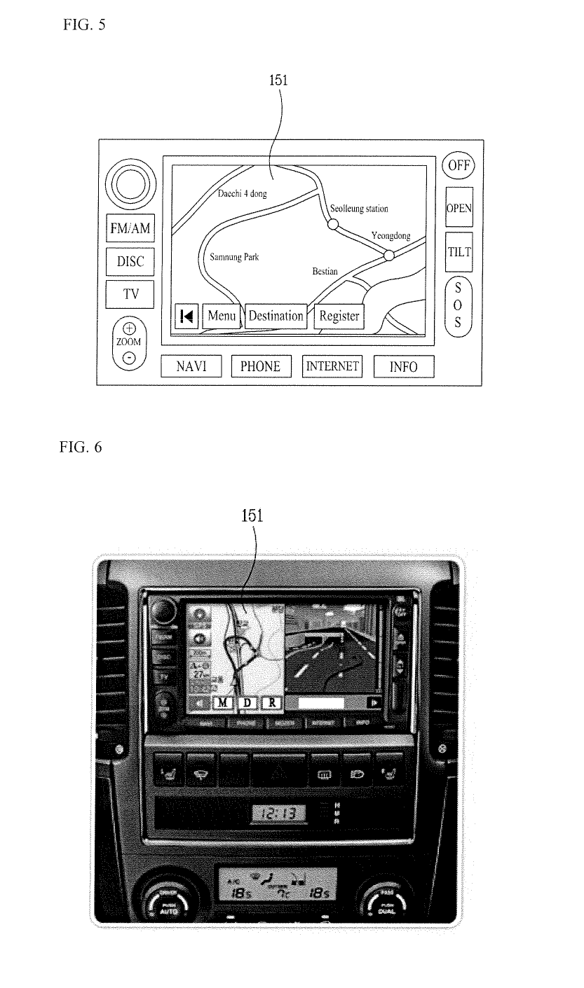

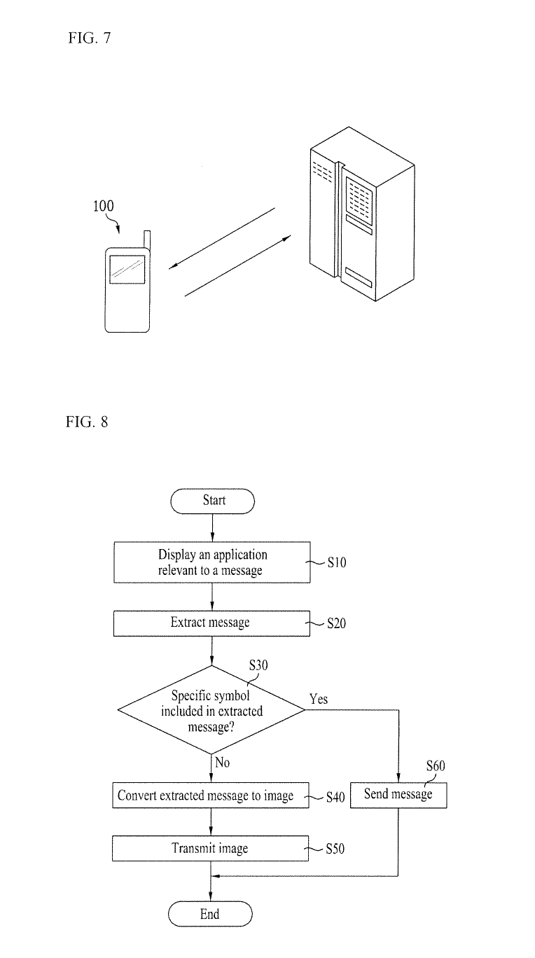

A mobile terminal according to one embodiment of the present invention is capable of performing a road guidance function. This example is shown in FIG. 5.

Referring to FIG. 5, a map having a current location marked thereon is displayed on the display 151. So, a user is facilitated to find a destination using the displayed map.

A mobile terminal capable of performing a road guidance function can be implemented into a navigation system provided to a vehicle or the like. This example is shown in FIG. 6.

Meanwhile, a mobile terminal 100 according to one embodiment of the present invention can use specific information for performing a specific function. The specific information may be the information stored in the mobile terminal or the information received through data communication with a server.

A method of transmitting data in a mobile terminal according to one embodiment of the present invention is explained as follows.

FIG. 8 is a flowchart for a method of transmitting data in a mobile terminal according to one embodiment of the present invention.

Referring to FIG. 8, first of all, an application relevant to a message is executed. If so, the executed application is displayed on the display 151 [10]. In this case, the application relevant to the message means an application for executing functions of a received message check, a message writing, a message transmission and the like. After the application relevant to the message has been executed, a message to be transmitted is extracted [S20]. The extracted message can include a message written by user's manipulation of the user input unit 130, a received message or a stored message. The message to be transmitted can include a character message. And, it is able to send the character message using SMS (short message service).

Meanwhile, a user is able to send the extracted message using SMS. Alternatively, the user is able to send the extracted message in a manner of converting the extracted message to an image. Namely, the user is able to transmit the image using MMS (multimedia message service) or e-mail.

The transmission of the image converted from the message is attributed to the possibility that a function supported by a transmitting terminal may differ from a function supported by a receiving terminal. For instance, in attempting to send a message, in case that a mobile terminal (transmitting side) transmits special characters, letter font and the like which are supportable by the mobile terminal (transmitting side), message sending can be successfully carried out. Yet, if a receiving side for receiving the sent message is not capable of supporting the same function, the received message is displayed in a broken state. So, a correspondent side is unable to correctly check contents of the received message. This may happen if a function not supported by an old terminal is applied to a latest terminal or if there exists a function implementation difference between terminal manufacturers.

Assuming that a receiving terminal is provided with a viewer for opening an image file, if an image converted from a message is sent to the receiving terminal, the contents of the message can be correctly recognized by the receiving terminal.

According to one embodiment of the present invention, in case of attempting to convert an extracted message to an image, it is able to decide whether to convert the extracted message to the image in a manner of checking whether specific symbols exist in the extracted message [S30]

In this case, the special symbols may include foreign characters (e.g., Japanese letters (hirakana, katakana)), signs, figure images, letter fonts, special characters, symbols drawn by user's handwriting if the mobile terminal 100 includes a touchpad, and the like. And, the symbols drawn by the user's handwriting can include characters, numerals, signs, drawings, and the like.

‘Checking whether the special symbols are included in the extracted message’ can be carried out by a user using his eyes. Alternatively, it can be checked by the mobile terminal 100 and the user is then informed of a result of the check by the mobile terminal 100.

In case that the mobile terminal 100 checks a specific symbol, it is able to use a specific symbol defaulted in the mobile terminal 100 or a special symbol set by a user. For instance, the special symbol can be defaulted as a specific symbol in the mobile terminal 100. In this case, if the special symbol is included in the extracted message, the controller 180 is able to display a popup window for indicating that a specific symbol is included. A user is able to set specific letters to foreign letters (e.g., hirakana and kadakana). In this case, if the set foreign letters are included in the extracted message, the controller 180 is able to display a popup window for indicating that specific symbols are included.

The above-described method of indicating that the specific symbols are included via the popup window is just exemplary, which does not restrict various implementations of the present invention. For instance, it is able to indicate that the specific symbols are included in the extracted message through audio output or vibration output.

In case that the specific symbols are included in the extracted message, it is able to convert the extracted message to an image [S40]. In this case, the extracted message can be rendered to include contents of the message only. For instance, a content part of the message except an indicator displayed on the display and the like is extracted only and is then converted to an image. In this case, the message part converted to the image includes a message part shown by a manipulation of a scroll key or a navigation key as well as a part displayed on the screen.

Subsequently, the image is transmitted [S50]. In this case, the controller 180 is able to transmit a message to transmit originally together with the image. In particular, the image transmission can be carried out by MMS or e-mail.

If the specific symbols are not included in the extracted message, it is able to send the extracted message without converting the extracted message to an image [S60].

The message transmission shown in FIG. 8 and reception of the sent message will be explained in detail as follows.

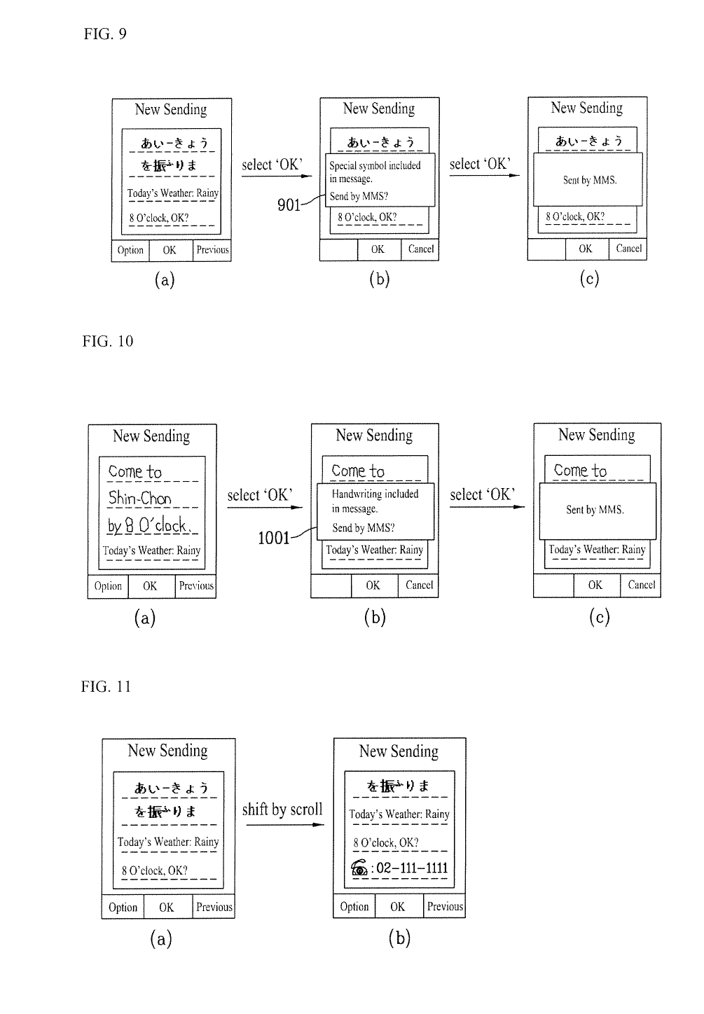

FIG. 9 is a diagram to explain a method of transmitting an image converted from a message in a mobile terminal according to one embodiment of the present invention.

In (a) of FIG. 9, shown is an example that a message including specific foreign letters and a specific symbol (umbrella symbol) is written. In this case, the foreign letters and symbol can be recognized as specific symbols. If ‘OK’ key displayed on a screen is inputted, the controller 180 is able to analyze whether specific symbols are included in the message. Namely, if ‘OK’ displayed on the screen is selected, an image shown in (b) of FIG. 9 is displayed on the screen.

Referring to (b) of FIG. 9, a popup window 901 for indicating that specific symbols are included in the message is displayed on the screen. If ‘OK’ is selected from the screen, the written message is converted to an image file and is then transmitted [(c) of FIG. 9]. In this case, it is able to transmit the image together with the original message. In particular, the image file transmission can be carried out using MMS.

According to one embodiment of the present invention, a message including symbols (characters, numerals, figures and the like included) written by user's handwriting is converted to an image and then transmitted. In order to recognize the user's handwriting, the mobile terminal 100 can include a touchpad. In this case, the controller 180 is able to recognize symbols written by the user's handwriting. And, a style of the handwriting can be displayed on the display 151.

FIG. 10 is a diagram to explain a method of transmitting an image converted from a message written by user's handwriting in a mobile terminal according to one embodiment of the present invention.

In (a) of FIG. 10, shown is an example that a message is written by handwriting. In this case, a symbol written by the handwriting can be recognized as a specific symbol. If ‘OK’ key displayed on a screen is inputted, the controller 180 is able to analyze whether the specific symbol is included in the message. Namely, if ‘OK’ is selected from the screen, an image shown in (b) of FIG. 10 is displayed on the screen.

Referring to (b) of FIG. 10, a popup window 1001 for indicating that a specific symbol is included in the message is displayed on the screen. If ‘OK’ is selected from the screen, the written message is converted to an image file and then transmitted [(c) of FIG. 10]. In this case, it is able to send an original message together with the image. And, the image file transmission can be carried out using MMS.

FIG. 11 is a diagram to explain a method of checking the image transmitted by the method shown in FIG. 9 in a receiving terminal having received the corresponding image.

In (a) of FIG. 11, shown is an image displayed when a receiving terminal opens a received image file. In (b) of FIG. 11, shown is an image that the part shown in (a) of FIG. 11 is shifted to another part using a scroll key. In particular, the receiving terminal is able to check whole parts of the transmitted image by scrolling the image using the scroll key.

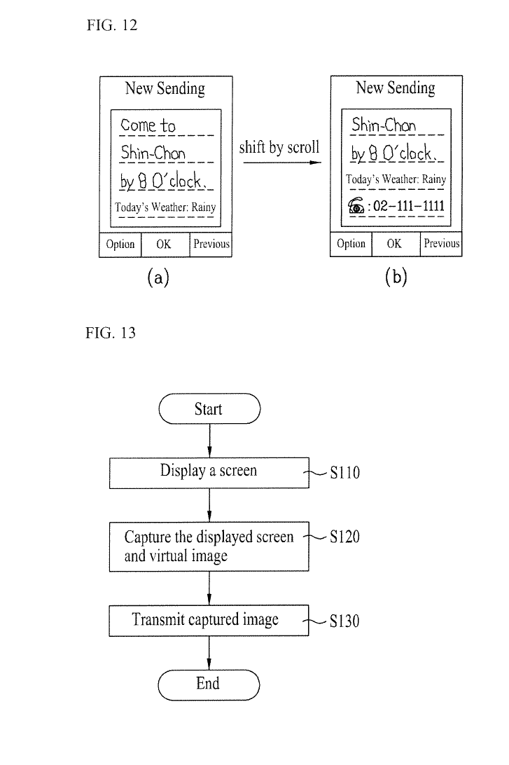

FIG. 12 is a diagram to explain a method of checking the image transmitted by the method shown in FIG. 10 in a receiving terminal having received the corresponding image. A method of checking an image is identical to the former method described in FIG. 11. So, its details are omitted in the following description.

FIG. 13 is a flowchart for a method of transmitting data in a mobile terminal according to another embodiment of the present invention.

Referring to FIG. 13, the controller 180 displays a screen on the display 151 [S110]. In this case, specific information can be displayed in the image. For instance, information relevant to road guidance received via a GPS module can be included in the displayed image or information relevant to a specific webpage can be included in the displayed image.

The controller 180 receives a signal relevant to an image capture and then performs image capturing on the displayed screen and a virtual screen that is not displayed [S120]. In this disclosure, ‘virtual screen’ means a screen that is not currently displayed on the display 151 but can appear by manipulating a scroll key, a navigation key and/or the like. And, ‘capturing’ means that specific information converts to an image form.

As mentioned in the description of the above method, the capturing is carried out on the virtual screen as well. This is because useful information may be contained in the virtual screen as well as the currently displayed screen.

The displayed screen and the non-displayed virtual screen can be captured into a single image file. By the capturing into the single image, it is able to enhance the convenience in data transmission and the convenience for a receiving terminal to check the reception of the captured image.

The captured image can be transmitted via the wireless communication unit 110. The capturing step S120 and the transmitting step S130 can be easily and conveniently executed using a single shortcut key.

According to one embodiment of the present invention, the controller 180 is able to transmit side information on the captured image together with the captured image. For instance, if the captured image relates to a broadcast image, the side information can include TV channel information or broadcasting system URL (uniform resource locator) information. If the captured image relates to an image for webpage information, the side information can include URL (uniform resource locator) information on the webpage.

According to one embodiment of the present invention, at least one of the captured screen and the virtual screen can include a road guidance screen received via the position-location module 115. For instance, it can include a road guidance screen received via a GPS module. By transmitting the image including the road guidance screen, a receiving terminal failing to be provided with a GPS module is able to use road guidance. In case that the screen relevant to the road guidance is captured, an estimated moving trace, an estimated arrival time or the like can be transmitted as side information.

The image captured in the mobile terminal 100 according to one embodiment of the present invention is explained in detail as follows.

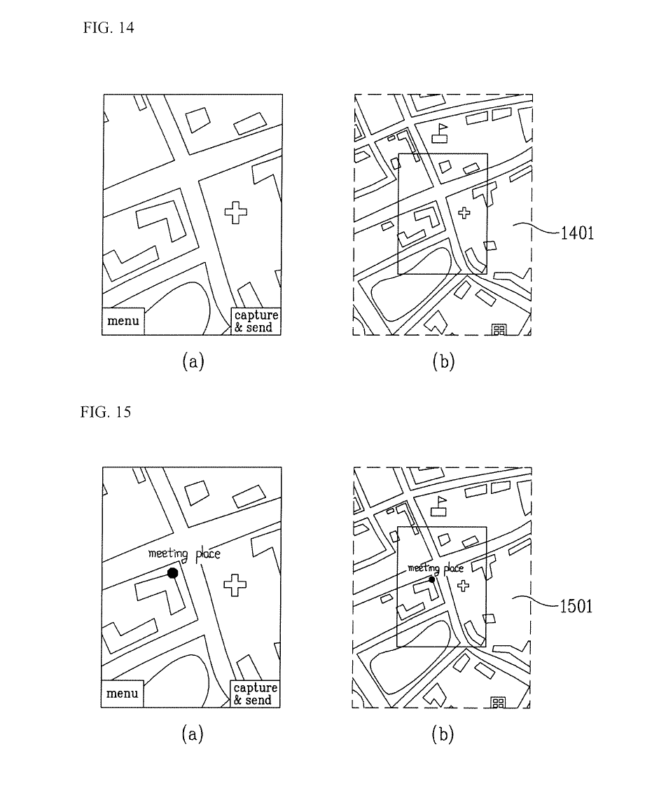

FIG. 14 and FIG. 15 re diagrams to explain a method of transmitting a screen and a virtual screen captured in a mobile terminal according to one embodiment of the present invention.

In (a) of FIG. 14, shown is a screen in which a map is represented. After information including the map is captured into an image, if the captured image is to be transmitted to a correspondent side, ‘capture & send’ is selected. If so, the controller 180 captures the map displayed in the screen and a map portion 1401 not included in the displayed screen and then sends the captured map and the captured map portion to the transmitting side [(b) of FIG. 14]. In this case, the captured image can be sent via MMS or e-mail.

The mobile terminal 100 according to one embodiment of the present invention can include a touchpad. In this case, symbols written on the touchpad can be captured as well. For instance, it is able to write a specific symbol on a displayed screen using the touchpad. This example is shown in FIG. 15.

FIG. 15 shows that a specific symbol written by user's handwriting is displayed in the screen shown in FIG. 14. In this case, the specific symbol written by user's handwriting is captured as well. The capturing and the transmission are identical to those shown in FIG. 14. So, their details will be omitted in the following description. Besides, a reference number 1501 indicates a virtual image.

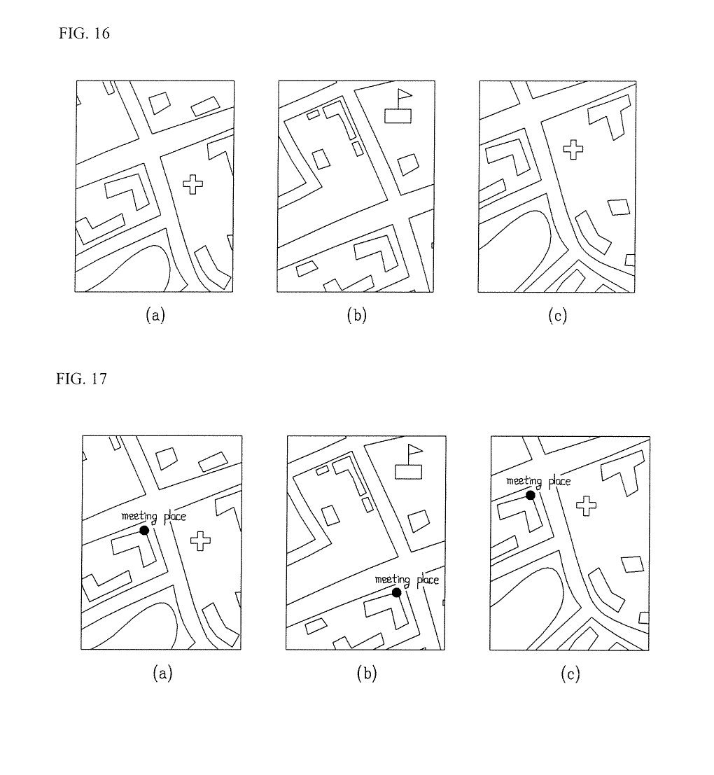

FIG. 16 is a diagram to explain a method of checking the image transmitted by the method shown in FIG. 14 in a receiving terminal having received the corresponding image.

In (a) of FIG. 16, an image generated from opening an image file received by a receiving terminal is displayed on a screen. In (b) or (c) of FIG. 16, the image shown in (a) of FIG. 16 is shifted to another portion using a scroll key. In particular, the receiving terminal is able to check whole portions of the received image by shifting portions of the image using the scroll key.

FIG. 17 is a diagram to explain a method of checking the image transmitted by the method shown in FIG. 15 in a receiving terminal having received the corresponding image. The image checking method is identical to that described for FIG. 16. And, its details will be omitted in the following description.

According to one embodiment of the present invention, the above-described methods of transmitting data in the mobile terminal can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, the computer can include the controller 180 of the mobile terminal.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal comprising:
a user input unit for a signal input;
a display displaying a screen for an execution of an application relevant to a message;
a controller extracting a message, converting the extracted message to an image, and controlling the image to be transmitted; and
a wireless communication unit for transmitting the image.

2. The mobile terminal of claim 1, wherein the controller converts the message to the image if a specific symbol is included in the message.

3. The mobile terminal of claim 2, wherein the message comprises at least one selected from the group consisting of a user-written message, a received message and a stored message.

4. The mobile terminal of claim 3, wherein the specific symbol is set by a user or defaulted.

5. The mobile terminal of claim 3, wherein the controller displays a popup window for converting the message to the image.

6. The mobile terminal of claim 3, wherein the controller controls the message to be transmitted together with the image.

7. The mobile terminal of claim 3, wherein the user input unit comprises a touchpad and,
wherein the message includes a symbol written on the touchpad by handwriting.

8. A mobile terminal comprising:
a user input unit for a signal input;
a display displaying a screen;
a controller performing image-capturing on the displayed screen and a virtual screen not displayed on the display, and controlling the captured image to be transmitted; and
a wireless communication unit for transmitting the captured image.

9. The mobile terminal of claim 8, wherein the captured image comprises a single image.

10. The mobile terminal of claim 8, wherein the controller transmits side information on the captured image together with the captured image.

11. The mobile terminal of claim 8, wherein the wireless communication unit comprises a position-location module for receiving position information and,
wherein at least one selected from the group consisting of the displayed screen and the virtual screen comprises a screen relevant to a road guidance received via the position-location module.

12. The mobile terminal of claim 8, wherein the user input unit comprises a touchpad and,
wherein the captured image includes a symbol written on the touchpad by handwriting.

13. A recording medium, in which a program is recorded, the program comprising:
displaying a screen for an execution of an application relevant to a message;
extracting a message;
converting the extracted message to an image; and
transmitting the image.

14. The recording medium of claim 13, wherein the image converting step comprises the step of converting the message to the image if a specific symbol is included in the message.

15. The recording medium of claim 14, wherein the message comprises at least one selected from the group consisting of a user-written message, a received message and a stored message.

16. The recording medium of claim 15, wherein the specific symbol is set by a user or defaulted.

17. The recording medium of claim 15, the image converting step comprising displaying a popup window for converting the message to the image.

18. The recording medium of claim 15, wherein the image transmitting step comprises transmitting the message together with the image.

19. The recording medium of claim 15, wherein the extracted message includes a symbol written by handwriting.

20. A recording medium, in which a program is recorded, the program comprising:
displaying a screen;
image-capturing the displayed screen and a virtual screen not displayed; and
transmitting the captured image.

21. The recording medium of claim 20, wherein the image capturing step comprises capturing the displayed screen and the virtual screen into a single image.

22. The recording medium of claim 20, wherein the image capturing step comprises transmitting side information on the captured image together with the captured image.

23. The recording medium of claim 20, wherein at least one selected from the group consisting of the displayed screen and the virtual screen comprises a screen relevant to a road guidance received via the position-location module.

24. The recording medium of claim 20, wherein the captured image comprises a symbol written by handwriting.

25. A method of transmitting data in a mobile terminal, comprising:
displaying a screen for an execution of an application relevant to message;
extracting a message;
converting the extracted message to an image; and
transmitting the image.

26. A method of transmitting data in a mobile terminal, comprising:
displaying a screen;
image-capturing the displayed screen and a virtual screen not displayed; and
transmitting the captured image.
